(19) United States
(12) Patent Application Publication
(10) Pub. No.: US 2017/0237349 A1
(43) Pub. Date: Aug. 17, 2017

(54) MULTI-MASTER POWER CONTROLLER WITH MULTIPLE FEEDBACK LOOPS

(71) Applicant: ALCATEL-LUCENT CANADA INC., Ottawa (CA)

(72) Inventors: Rami LABIB, Ottawa (CA); James M. SCHRIEL, Kanata (CA)

(73) Assignee: ALCATEL-LUCENT CANADA INC.

(21) Appl. No.: 15/042,889

(22) Filed: Feb. 12, 2016

(51) Int. Cl. H02M 3/158; H02M 1/084

(52) U.S. Cl. CPC H02M 3/158; H02M 1/084; H02M 2001/0009

(57) ABSTRACT

A multi phase power supply system includes a plurality of power controllers, each power controller configured to control a DC-DC power converter, a plurality of compensation loops configured to receive outputs from the DC-DC power converters and input feedback to the plurality of power controllers, wherein the plurality of power controllers are configured to operate the power converters phase shifted from one another to decrease a reaction time to load disturbances on a power rail.

### TECHNICAL FIELD

Embodiments described herein are generally directed to improving the frequency response in multi-phase power controllers and power systems related thereto.

### BACKGROUND

As process technology allows smaller and smaller integrated circuits, more gates are possible on a single chip. The operation of multiple circuits within a given time period leads to increased processing power and large current step functions in a very short period of time. Power supplies should to be designed to handle these increasingly dynamic loads and multi-phase power systems are widely used with processors to provide a high amount of current on a power rail.

### BRIEF DESCRIPTION OF THE DRAWINGS

FIG. 1 illustrates voltage and current reactions to loads on a voltage rail in accordance with embodiments described herein;

FIG. 2 illustrates a graph of normalized power losses with the switching frequency with embodiments described herein;

FIG. 3 illustrates a related art multi-phase buck converter;

FIG. 4 illustrates switching frequency and phase-shift for a multi-phase controller in accordance with embodiments described herein;

FIG. 5 illustrates a 4-phase system with a multi-master controller in accordance with embodiments described herein; and

FIG. 6 illustrates internal circuitry of a master controller in accordance with embodiments described herein.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various exemplary embodiments relate to a multi-phase power supply system, including a plurality of power controllers, each power controller configured to control a DC-DC power converter, a plurality of compensation loops configured to receive outputs from the DC-DC power converters and input feedback to the plurality of power controllers, wherein the plurality of power controllers are configured to operate the power converters phase shifted from one another to increase a reaction time to load disturbances on a power rail.

The power converters may include a converter channel and a current sense circuit. An analog to digital converter may receive an output of the current sense circuit, the analog to digital converter being external from the power controller.

The number of compensation loops may be greater than or equal to two.

The compensation loops may include a current feedback loop and a voltage feedback loop.

The current feedback loop may include a current sharing loop to divide a total current between multiple converter circuits.

The plurality of power controllers may be disposed on a single chip.

The plurality of power controllers may be disposed on separate chips.

The power controllers may include a memory and a look-up table to set appropriate gain for the compensation loops.

Various exemplary embodiments also relate to a power control system, including a first power converter circuit configured to operate at a first phase and to convert an input DC voltage to a different output DC voltage, the first power converter circuit including a plurality of feedback loops, a second power converter circuit configured to operate at a second phase different than the first phase and to convert a second input DC voltage to a second output DC voltage, the second power converter circuit having a plurality of feedback loops, a plurality of power controllers to regulate the operation of the power converter circuits and keep them in phase relation with each other in order to increase a frequency response of the system.

The power converter circuits may include a converter channel and current sense circuit. An analog to digital converter may receive an output of the current sense circuit, the analog to digital converter being external from the power controller.

The system may include a current feedback loop and a voltage feedback loop. The current feedback loop may include a current sharing loop to divide a total current between multiple converter circuits.

The plurality of power controllers may be disposed on a single chip or on separate chips.

The power controllers may include a memory and a look-up table to set appropriate gain for the system.

Various exemplary embodiments also relate to a method of operating a power supply, including receiving a load disturbance on a voltage rail connected to several channels of a multi-phase buck converter, sensing feedback voltage and current values from a plurality of channels, inputting the feedback into a plurality of power controllers having respective compensation loops, and controlling the operation of the plurality of channels and respective compensation loops to increase the reaction time of the power supply to the load disturbance on the voltage rail.

The number of compensation loops may be greater than or equal to two.

Sensing feedback may include using a memory and a look-up table to set appropriate gain for the compensation loops.

### DETAILED DESCRIPTION

The description and drawings illustrate the principles of the invention. It will thus be appreciated that those skilled in the art will be able to devise various arrangements that, although not explicitly described or illustrated herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

One goal regarding implementing a successful power controller is to manage the current demand, while maintaining a good efficiency. Another goal is to have a small form factor, and medium losses. When dealing with power supplied on a voltage rail and the disturbance on a rail caused by load steps (i.e., fast changes in the load on the voltage rail), the response time to accommodate the disturbance on the rail is a factor to be considered.

A power distribution network (“PDN network”) can be a group of power circuits to provide power or can be a model of power distribution in an integrated circuit or power system to simulate such things as the amount of decoupling capacitors on a board. The PDN network can act as a step response current demand model including an LC network characterizing the plane and vias illustrating connections, inductances and planes.

During a load step there will be a disturbance on the voltage rail. The magnitude of that disturbance is a function of the size and rate of the load step, the LC characteristics of the PDN network and the ability of a switcher to react and compensate for the step.

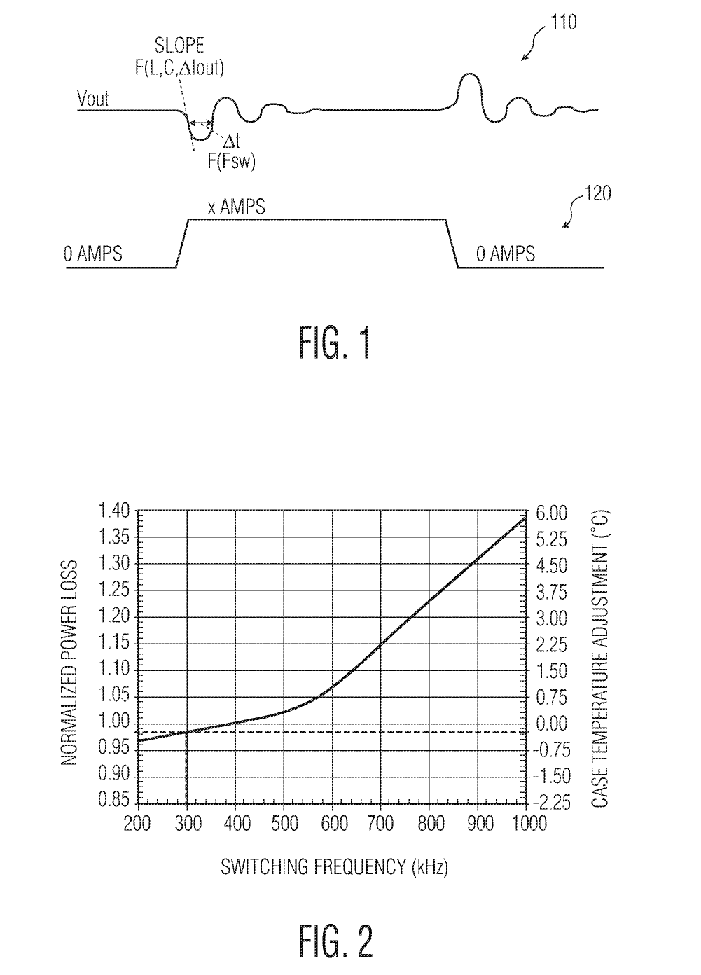

FIG. 1 illustrates voltage and current reactions to loads on a voltage rail. As illustrated in FIG. 1, the slope of the dip on a voltage rail 110 can be determined by L/C characteristics of the PDN network and the magnitude of the change in current step load, Δlout, as indicated by the current waveform 120. The duration Δt of the dip is a function of switching frequency (Fsw). The faster the Fsw, the faster the supply will react to a step load.

The absolute change in voltage ΔV allowed on the voltage rail is specified by the integrated circuits that use the rail. Today's processors and memory can produce very fast and large current steps yet only can tolerate small deviations on the voltage rail.

Designs of buck converters that desire small space and good reaction time attempt to decrease the size of components so that smaller inductive values can be used, to increase the frequency of a power switch. However many increases in switching frequency are coupled with increased power losses, therefore decreasing inductor size may not be a good solution.

There are three methods for improving the frequency response of a dc-dc switch that is part of a buck converter circuit. Each of these methods will now be described.

First, improve the PDN network: this can entail using more capacitors or capacitors having a higher quality, improving power planes and other layout features. This solution can be a double edged sword because as capacitance increases, any disturbance on the rail is dampened which may adversely affect the ability of the controller to react to the step.

Second, decrease the value of the dc-dc switcher inductor: as noted above, this may allow the switcher to react quicker but a lower value inductor may require more capacitance on the rail to keep the same output ripple.

Third, increase the switching frequency (Fsw) of the switcher/driver: this option has the largest impact, but has a drawback because increasing Fsw also increases the losses in a FET driver. Output stages become less efficient as Fsw increases.

FIG. 2 illustrates the relation of switching frequency FSW with output stage power loss and shows the increase of temperature of the hardware attached thereto.

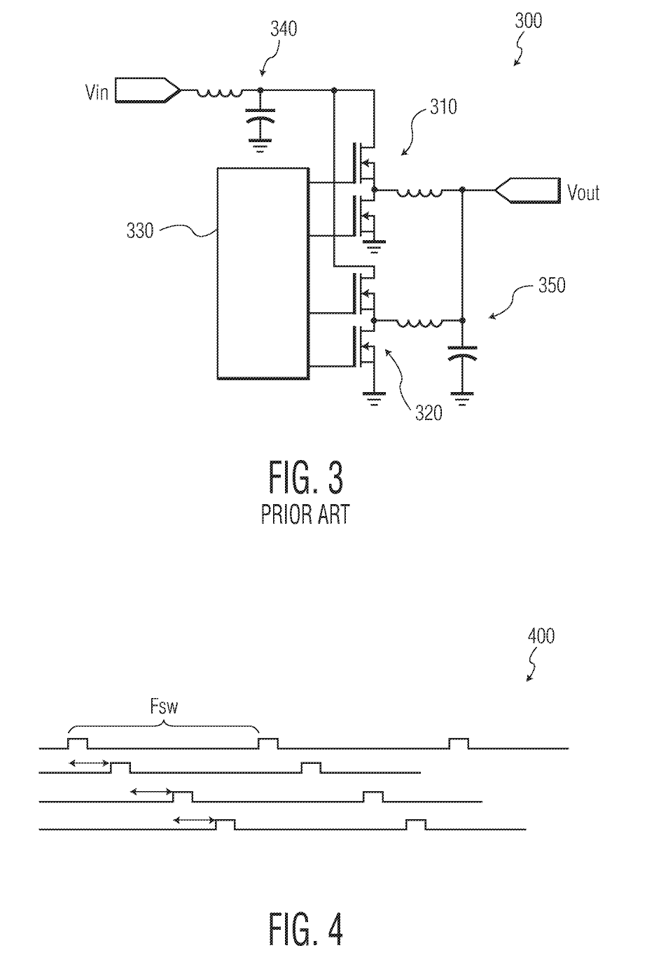

FIG. 3 illustrates a related art multi-phase buck converter 300. A multi-phase buck converter has emerged as a leading candidate for meeting the power challenge of the next generation processors and power controllers. A topology of a buck converter 300 is illustrated that includes multiple synchronous buck converters 310 and 320 configured to share current while powering a common load through Vout. Controller 330 controls the switching frequency of the converters 310 and 320 which are phase shifted and result in cancellation of the ripple currents seen by the input 340 and output filter 350.

An advantage of the multiphase buck topology is that it is relatively simple and provides excellent transient response, high efficiency, small size, and low cost. The effective switching frequency is multiplied by the number of phases while the load is divided by the number of phases. The multiphase buck converter is commonly powered from a 5V or 12V bus derived from an AC-DC power supply. The trend is towards using 12V to lower the bus current and therefore reduce resistive losses in the printed circuit board (PCB) and connectors.

In prior art designs, increasing the switching frequency results in greatly reduced switcher efficiency. For example at 400 Khz and 30 A a given FET might dissipate 3 W. That same part at 800 Khz and 30 A will dissipate 22% more power or 3.66 W. This becomes very significant in larger systems.

With prior art solutions, there was little benefit from the use of N channels. Using a single master controller, the controller 330 illustrated in FIG. 3 was responsible for all the positions of the loop, and the single controller 330 attempted to allocate control signals and current to multiple drivers based on a single feedback loop.

The multi-master controller configuration in accordance with embodiments described herein can maintain a lower Fsw and good efficiency yet still achieve the desired faster frequency response

Embodiments described herein include technical enhancements that provide good frequency response without sacrificing efficiency. The basic concept is a multi-master, multi-phase system that provides scalability, superior frequency response and maintains high efficiency.

FIG. 4 illustrates switching frequency and phase-shift 400 for a 4-phase controller. In a multi-phase configuration there can be a single master controller running a single compensation loop to control a plurality of output blocks that are configured to create the same Vout rail. The output blocks are phase shifted from one another to minimize the id-dt on the rail. For example in a 4-phase configuration illustrated in FIG. 4, the phases have relative phase shifts of 0°, 90°, 180°, and 270° respectively. This allows rails to operate with higher current demand requirements than could be handled by a single phase, but it doesn't enhance the frequency response of the rail. Since there is only one control loop the response time is about 1/10th of the switching frequency (Fsw), the same as it would be for a single phase configuration.

Embodiments described herein use multi-phase architecture in a multiple-master controller arrangement, each master-controller having its own control loop. The individual phases may be phase shifted and each phase is compensated for independently. For example in an n-phase configuration the response time is 1/10th of Fsw divided by n. This is significant in a 4-phase system running at 400 Khz because the effective reaction time would be equivalent to increasing Fsw to 4×Fsw (1600 Mhz). If this increase in switching frequency were attempted using a multi-phase system that does not have multiple controllers and multiple control loops, losses in the switching DC-DC FETs would be orders of magnitude higher at 1600 Mhz compared to 400 Khz.

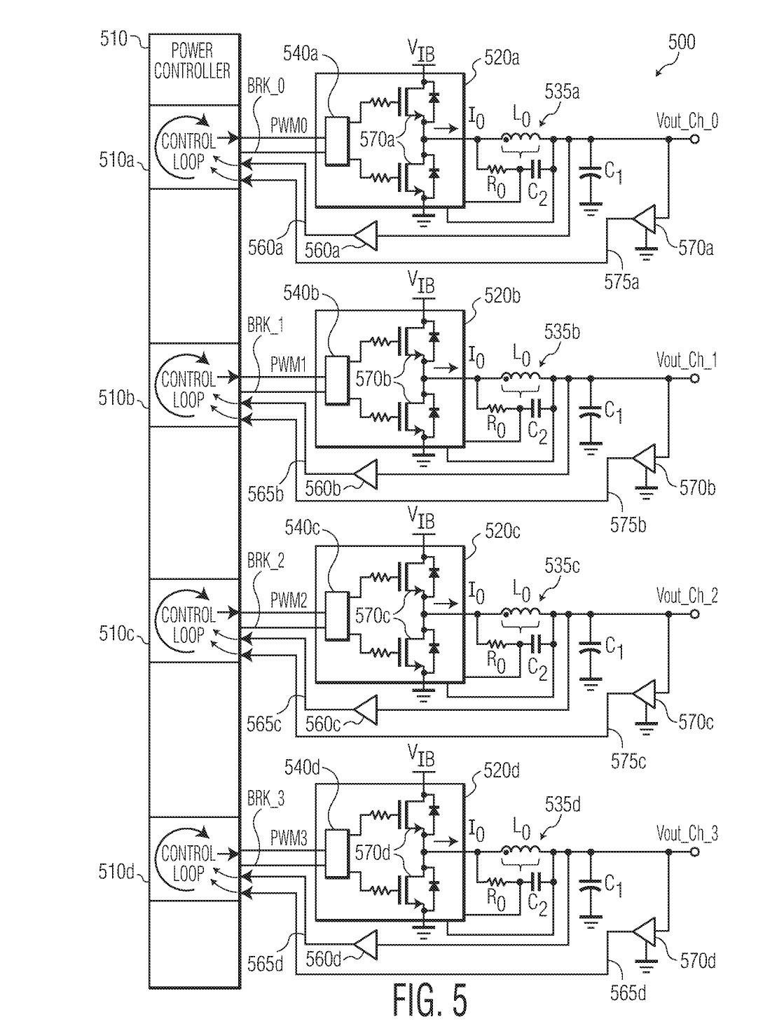

FIG. 5 illustrates a multi-phase system 500 with a multi-master power controller, driver circuitry, and feedback circuitry. Though illustrated as a 4-phase system, embodiments are not limited thereto. The number of phases could be two, three, six, eight, ten or more, depending on the design of the system. The multi-phase system 500 may drive a load connected to Vout_A and may include a power controller 510. The power controller 510 may include a plurality of separate dedicated independent controller circuits 510a, 510b, 510c, and 510d for each converter channel 520a, 520b, 520c, and 520d, or the power controller 510 may be in the form of four independent separately connected controllers. The separate controllers may have their own independent control or compensation loops to handle feedback independently from other phase controllers. The power controller 510 may, for example, be implemented by a field programmable gate array. Interconnected electrically between load and control circuit 510 are, for example, four synchronous-rectified buck channels or converter channels 520a, 520b, 520c, and 520d. Control circuit 510 provides at each output from multi-masters 510a, 510b, 510c, and 510d, a separate and independent PWM signal, PWM1, PWM2, PWM3, PWM4, to each converter channel 520a, 520b, 520c, and 520d.

As illustrated in FIG. 5, the multi-phase buck converter system 500 may have four output stages each corresponding to one phase thereof and including a pair of MOSFETs 570 connected in series, manipulated by respective drivers 540a, 540b, 540c and 540d in respective phases, which are controlled by multi-masters 510a, 510b, 510c, and 510d. A plurality of brake signals BRK_0, BRK_1, BRK_2 and BRK_3 are also input to respective drivers 540a, 540b, 540c and 540d to turn off top and bottom MOSFETSs 570a, 570b, 570c, and 570d which helps the circuit respond faster to overshoot transients. The two transistor switches 570a, 570b, 570c, and 570d are connected in series between an input voltage, here an intermediate bus voltage V_{IB}, and ground. Drivers of the channels 520a, 520b, 520c, and 520d respectively receive pulse width modulating control signals PWM1-PWM4 and brake signals generated respectively by the multi-masters 510a-510d and accordingly switch the corresponding transistor switches to provide channel currents.

For example, for the master controller 510a and buck converter channel 520a, the channel currents commonly form an output current I0 to charge a capacitance C1 and generate an output voltage Vout_Ch_0 to drive a load. Output circuitry also may include a resistive element R0 and capacitor C2 in parallel with L0 that are a part of a current sense circuit 535a. Inductor current I0 through L0 can be sensed by connecting series resistor R0 and a capacitor network C2 in parallel with the inductor L0 and measuring the voltage across the capacitor C2. The resistor R0 and capacitor C2 may be chosen so that the time constant of R0 and C2 equals the inductor time constant, which is the inductance L0 over the inductor DC resistance. If the two time constants match, the voltage across C2 is proportional to the current through L0, and the sense circuit 535 can be treated as if only a sense resistor with the value of R0 was used. The mismatch of the time constants does not affect the measurement of inductor DC current, but affects the AC component of the inductor current.

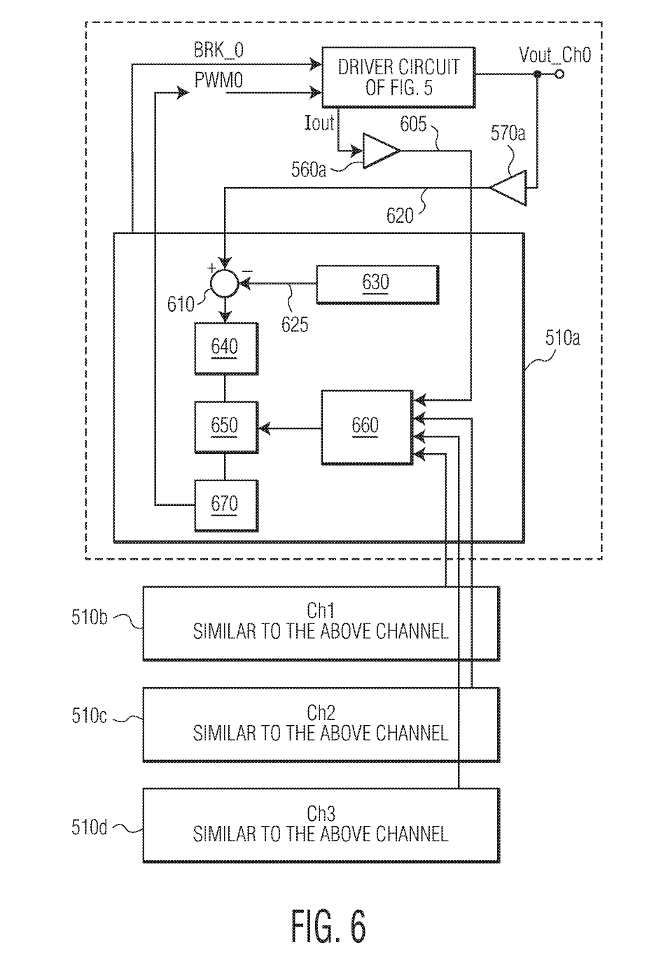

The controller 510a, for example, may detect channel currents of one phase at node I0 that are input to analog to digital (ADC) converter 560a, and sent through signal line 565a as feedback. ADC 560a is positioned close to driver circuitry 520a, external to power controller 510 or 510a in order to reduce noise transmitted in the output signal. Similarly the master 510a may detect an output voltage at Vout_Ch_0, converted by ADC 570a, also external to the power controller circuits, and received through signal line 575a. Sampling rates for ADC 560a and 570a are on the order of 10 Ms/s. The control loop may include the various components illustrated in FIG. 6 and described herein. Accordingly the master controller 510a may modulate the duty cycle of the transistor switches of the channels 520a-d. In this manner the controller 510 or 510a-510d may sample the outputs of the buck converter channels 520a-520d separately and receive the feedback separately, in order to respond more quickly to voltage and current demands on a power rail. This may lead to various performance increases of the multi-phase buck converter system 500.

FIG. 6 illustrates a plurality of master-control circuits 510a-510d and circuit components that are included therein. A master controller 510a may include an adder/subtractor component 610 to determine a difference between a measured voltage value 620 output through signal line 575a from ADC 570a and a programmable set output voltage value 625 output from a memory location 630. Based on a voltage level at a given channel, the output voltage signal is compared with the programmable set value 625 for the desired voltage operation. An error signal that is the difference of the (Vout—desired Voltage) is fed into a lookup table 640 as a non-linear mapping function that may set appropriate gain for the loop. This table can help reject small noise amplification and permit high gain for large error signal. A compensation loop 650 can be implemented in a digital domain with configurable parameters for a high order control loop which acts a PID controller (proportional, Integral and differential) with programmable coefficients.

A measured current 605 through signal line 565a output from ADC 560a may be input into a current sharing loop 660. Current sharing loop 660 may be a slower loop than digital compensation circuit 650. Current sharing loop 660 may help to maintain current sharing by working with the digital compensation circuit 650 to allocate the total current by the number of channels implemented, and receive input from the current sensing circuit 535a. The current sharing loop may divide a total current between multiple converter circuits 520a-520d. The resultant current may be considered the desired current for a given channel. The output from the digital compensation circuit 650 is input to PWM generator 670 which then inputs a corrected PWM signal for each channel back into driver circuits 540a-540d.

Inside the power controller, everything may be digital. At a sampling frequency, when the error amplifier receives a value, the error amplifier may compare it with a desired voltage for the rails. The error amplifier then produces an error, and the error amplifier may apply a gain to compensate for the error which gain may be non-linear.

Referring to FIGS. 5 and 6, use of multiple feedback loops provides a separate feedback signal from each of converter channels 520a, 520b, 520c, and 520d to each control circuit channel. The separate feedback signals are each proportional to the converter channel current being sourced by a corresponding converter channel. The operation of each channel 520a, 520b, 520c, and 520d is then individually and separately adjusted on the basis of the fed-back converter channel current and voltage to improve the frequency response of the system.

Feedback paths 565a-d and 575a-d may electrically connect output Vout_A of converter 500 to feedback inputs of multi-masters 510a-510d. Control circuit 510 or 510a-510d may thus receive via feedback paths 565a-d and 575a-d the current and voltage being supplied to the load at a rate of four times Fsw and can react faster to drops in voltages on the voltage rails.

Embodiments include predetermined allowances in the controller 510 to prevent the multiple masters 510a-510d from competing with each other. The control loop may include several features or characteristics. The control loop may be set with the same loop parameters for zeros, poles and gain. A purely digital control loop greatly facilitates this to ensure each master behaves in the same manner.

The gain of the error amplifier has a non linear behavior where if the error exceeds a certain value it will be sorted to another bin with less gain. This helps to enhance loop stability when high gain settings are present for the compensation loop. This prevents a given master-controller from over-reacting and throwing the system out of control.

Current monitoring is per channel, and because of the exact symmetry in the digital designs of the control loops and the equal phase staggering, the current sharing is near perfect.

Embodiments described herein can be applied to any number of phases. This example illustrates four-phases tied together to create Vout_A. The controller 510 may sample voltage (Vout_A) and current for each phase. This example illustrates four separate samples and four ADCs going directly back to the controller 510 and the proper control loops 510a-510d.

The sampled information is used for individual control loops. In this example there would be 4 control loops. The controller uses digital control loops which are set 100% identically ensuring common response.

The multiple phases may be frequency locked and phase shifted so that they are not attempting to compensate at the same time.

By running multiple control loops (multiple-masters) the reaction time may be increased by a factor of the number of control loops, and the frequency response may be greatly improved. The switching circuits 520a-520d of the controller 510 will be able to react four times faster than in a previous switcher configurations. This means that a step response on Vout_A would be reacted to four times faster than a point of load (POL) network running at a similar frequency. Thus the switching frequency Fsw can be kept relatively low to improve efficiency and minimize losses, yet the overall frequency response is improved.

In embodiments described herein, digital control may be beneficial because of the freedom to have N channels, and every channel has an independent control loop. This is not a master-to-slave configuration of controller-to-driver based on a single control loop as is known in the art. As illustrated in FIG. 5, each driver 540a-540d has a master controller 510a-510d associated therewith, and there is communication between the master controllers to share system power and not overlap when operating in a multi-phase configuration. Embodiments described herein may also be applied in the analog domain.

Each buck converter channel 520a-520d has its own respective ADC converter 560a-560d which is a viable alternative to the over-sampling of a single ADC positioned in a single location used in multi-phase systems in the prior art. Thus each phase is sampled and the reaction times can be more precise for each phase.

As described herein, in a multiple-phase design, multiple ADCs are used and each converter may sample current and voltage at a different spot. This data may be fed to a different control loop associated with a different channel, as illustrated in FIG. 5. These loops will try to immediately react.

Since the ADCs 560a-d are on full time, with multiple channels, the system can be run at multiple times the speed of a single control loop, or multiple times the speed depending on the number of control loops, without increasing the switching frequency, using the method of phase staggering and having independent loops to get the final output.

In the prior art, the way to get more feedback was to switch the drivers at higher frequencies, because ADC sampling was performed at the same rate as the switching frequency of the transistors, which increased current draw and also increased the heat of the switch which is lost. In the present invention, the switching frequencies are kept the same and independent control loops are added to each multi-phase buck converter. Thus instead of one measurement being taken a given switching frequency, in a multi-phase buck converter, multiple separate measurements are taken.

In embodiments described herein there is no limit on the scaling because each control loop operates independently of its neighbor. More channels equates to more current out of a fixed design, and better ripple shape of an output signal on a voltage rail. Because every switch creates a saw tooth like wave, before one wave decreases, another raises the peak. Thus, increasing the number of channels may provide improvements in shortening and measuring the peak to peak distance between output waves, which may improve the output performance of the buck converter.

In cases where there is a large current demand, such as 100 amps in 10 micro seconds, there is a challenge to quickly sense the error and quickly compensate for it. Thus the increase in response time discussed herein.

The controller can be a single piece of hardware, for example, a field-programmable gate array, with multiple sub-controllers thereon, or each controller can be a separate chip, with means of communication between each controller to control each phase so that the loops may know what each other loop is doing for current sharing purposes.

Embodiments described herein are valuable because they address frequency response without increasing switching frequency which would adversely affect dc-dc efficiency. In systems that consume thousands of Watts of power an increase of even 1% of converter efficiency is significant, which this design represents.

The embodiments described herein provide an innovative way to maintain the best possible dc-dc switcher efficiency and provide faster response times to handle transients. It can be achieved with minimal or no bill of material (BOM) cost increase and yet provides significant performance improvement.

As process technology shrinks and loads become increasingly dynamic, innovative advancements like this that make use of existing power supply components and topologies and provide improved performance may be the only way to meet system power demands.

It should be appreciated by those skilled in the art that any block diagrams herein represent conceptual views of illustrative circuitry embodying the principles of the invention.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

1. A multi-phase power supply system, comprising:
a plurality of independent power controllers, each power controller configured to control a DC-DC power converter;
a plurality of independent compensation loops configured to receive outputs from the DC-DC power converters and input feedback to the plurality of independent power controllers,
wherein the plurality of independent power controllers are configured to operate the power converters phase shifted from one another to decrease a reaction time to load disturbances on a power rail, and
wherein the independent compensation loops include a current feedback loop and a voltage feedback loop, and wherein the voltage feedback loop determines a difference between a measured voltage value and a set voltage value.

2. The system of claim 1, wherein the independent power converters comprise a converter channel and a current sense circuit.

3. The system of claim 2, comprising an analog to digital converter to receive an output of the current sense circuit, the analog to digital converter being external from the independent power controller.

4. The system of claim 1, wherein the number of independent compensation loops is greater than or equal to two.

5. (canceled)

6. The system of claim 1, wherein the current feedback loop includes a current sharing loop to divide a total current between multiple converter circuits.

7. The system of claim 1, wherein the plurality of independent power controllers are disposed on a single chip.

8. The system of claim 1, wherein the plurality of independent power controllers are disposed on separate chips.

9. The system of claim 1, wherein the independent power controllers include a memory and a look-up table to set appropriate gain for the compensation loops.

10. A power control system, comprising:
a first power converter circuit configured to operate at a first phase and to convert an input DC voltage to a different output DC voltage, the first power converter circuit including a plurality of feedback loops;
a second power converter circuit configured to operate at a second phase different than the first phase and to convert a second input DC voltage to a second output DC voltage, the second power converter circuit having a plurality of feedback loops; and
a plurality of independent power controllers to regulate the operation of the power converter circuits and keep them in phase relation with each other in order to increase a frequency response of the system,
wherein the independent compensation loops include a current feedback loop and a voltage feedback loop, and wherein the voltage feedback loop determines a difference between a measured voltage value and a set voltage value.

11. The power control system of claim 10, wherein the power converter circuits comprise a converter channel and current sense circuit.

12. The system of claim 11, comprising an analog to digital converter to receive an output of the current sense circuit, the analog to digital converter being external from the power controller.

13. (canceled)

14. The system of claim 1, wherein the current feedback loop includes a current sharing loop to divide a total current between multiple converter circuits.

15. The system of claim 10, wherein the plurality of independent power controllers are disposed on a single chip.

16. The system of claim 10, wherein the plurality of independent power controllers are disposed on separate chips.

17. The system of claim 10, wherein the independent power controllers include a memory and a look-up table to set appropriate gain for the system.

18. A method of operating a power supply, comprising:
receiving a load disturbance on a voltage rail connected to several channels of a multi-phase buck converter;
sensing feedback voltage and current values from a plurality of channels;
inputting the feedback into a plurality of independent power controllers having respective independent compensation loops; and
controlling the operation of the plurality of channels and respective independent compensation loops to decrease the reaction time of the power supply to the load disturbance on the voltage rail,
wherein sensing feedback includes using a memory and a look-up table to set appropriate gain for the independent compensation loops.

19. The method of claim 18, wherein the number of independent compensation loops is greater than or equal to two.

20. (canceled)
